(19) United States
(12) Patent Application Publication
(10) Pub. No.: US 2024/0331306 A1
(43) Pub. Date: Oct. 3, 2024

(54) ROTATING DISPLAY FOR 360-DEGREE VISUAL CONTENT

(71) Applicant: Glenn Robert Josefosky, Troy, MI (US)

(72) Inventor: Glenn Robert Josefosky, Troy, MI (US)

(21) Appl. No.: 18/192,830

(22) Filed: Mar. 30, 2023

(51) Int. Cl. G06T 19/00; G06T 15/20

(52) U.S. Cl. CPC G06T 19/003; G06T 15/20; G06T 2215/16; G06T 2219/2016

(57) ABSTRACT

A system and method for representing 360-degree visual content on a two-dimensional (2D) display by rotating the 2D display monitor. The rotational position data of the 2D display monitor is determined by a rotary encoder, so that a processor can synchronize the 360-degree visual content in real time with the rotating display monitor so that the display of the 360-degree visual content can be viewed by many people simultaneously without the need for headgear.

### BACKGROUND OF THE INVENTION

The present invention relates to panoramic display systems and, more particularly, a rotating display for representing 360-degree visual content.

Viewing 360-degree panoramas and similar panoramic imagery usually requires a virtual reality (VR) headset and cannot be viewed on a regular TV display or monitor. VR systems require a user to wear a single-user set of eyeglasses or single-user headset, preventing multiple viewers from enjoying the panoramic content simultaneously. Accordingly, VR systems are not geared toward multiple user public displays.

As can be seen, there is a need for a rotating display for 360-degree visual content so that the display can be viewed by many people and does not require wearing a headset.

### SUMMARY OF THE INVENTION

The present invention embodies a system with a 360-degree rotating display that represents panoramic content, wherein a user can rotate the display to view any portion of the panorama.

The rotating display can incorporate any size monitor or display and does not require a VR headset to view the content.

In one aspect of the present invention, a method of displaying 360-degree/3D visual content on a two-dimensional display device, the method provides synchronizing a representation of the 360-degree visual content with a rotation of the two-dimensional display device displaying a portion of the representation.

In another aspect of the present invention, the method of displaying 360-degree/3D visual content on a two-dimensional display device further includes wherein a rotary encoder is operatively associated with the 2D display device so as to determines a rotational position data set for the 2D display device, and wherein a computer is configured to control the synchronizing said representation based on the rotational position data set, wherein the rotational position data set includes an angular velocity and an angular acceleration for the display device, wherein the 3D visual content is a pre-made panoramic image, wherein the 3D visual content is a real-time image, wherein the computer receives 3D object-space data that represents one or more 3D object defined by the 3D visual content, and wherein the computer is configured to compare the 3D object-space data sets relative to the rotational position data set for representing the 3D visual content on the 2D display device; further including: operatively associating an augmented reality (AR) camera with the 2D display device, wherein the computer is configured to overlay AR images captured by the AR camera onto the 3D visual content representation, wherein the AR is mechanically and directly connected to the 2D display device.

In yet another aspect of the present invention, a system for representing a 360-degree visual content on a two-dimensional display, the system includes the following: a two-dimensional (2D) display device operatively associated with a rotary power coupling; a rotary encoder operatively associated with the 2D display device so as to determines a rotational position data set for the 2D display device; a computer operatively associated with the 2D display device and the rotary encoder, wherein the computer is configured to synchronize a representation of the 360-degree visual content on the 2D display device based on the rotational position data set; and an augmented reality (AR) camera mechanically connected to the 2D display device, wherein the computer is configured to overlay AR images captured by the AR camera onto the representation of the 360-degree visual content.

These and other features, aspects and advantages of the present invention will become better understood with reference to the following drawings, description, and claims.

### BRIEF DESCRIPTION OF THE DRAWINGS

FIG. 1 is a schematic view of an exemplary embodiment of the present invention.

FIG. 2 is a flow chart view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system and method for representing 360-degree visual content on a two-dimensional (2D) display by rotating the 2D display monitor. The rotational position data of the 2D display monitor is determined by a rotary encoder, so that a processor can synchronize the 360-degree visual content with the rotating display monitor so that the display of the 360-degree visual content can be viewed by many people simultaneously without the need for headgear.

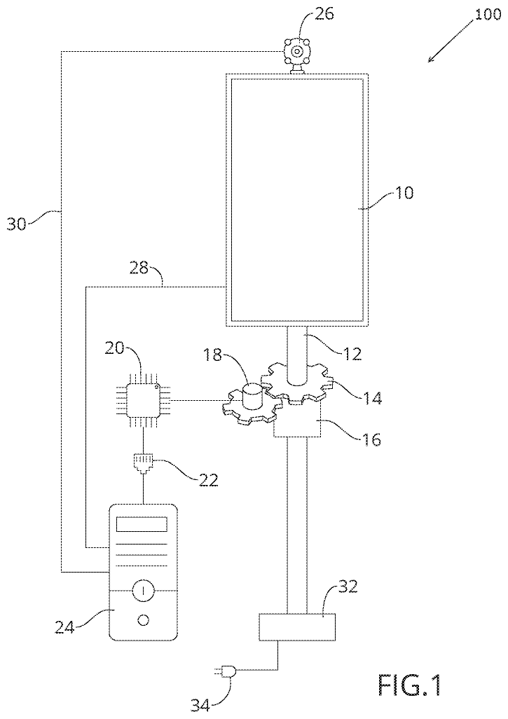

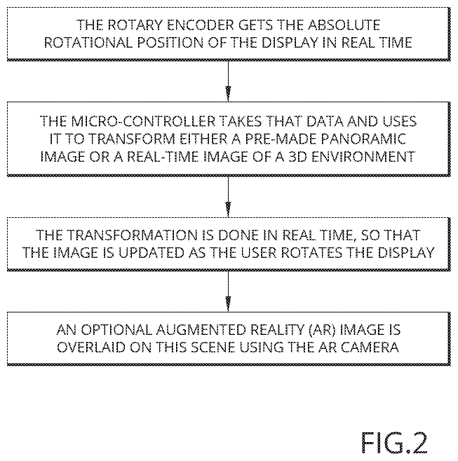

Referring now to FIGS. 1 and 2, the present invention may include a rotating 2D display system 100 for displaying 360-degree visual content. The display system 100 embodies a display monitor 10 operatively associated with a rotational stand 12. The rotational stand 12 may have a base 32 for support as well as a power cord 34 for obtaining power.

The rotational stand 12 may also be operatively associated to a rotary power coupling 16 to impart rotation to the display monitor 10 by way of the rotational stand 12. The rotary power coupling 16 may be operatively associated with a rotary encoder 18 by way of gears 14. A microcontroller 20 may be electrically coupled to the rotary encoder 18. The microcontroller 20 may be connected to a computer 24 by way of a network 22.

An image electrical connection 30 may be provided between the computer 24 and an augmented reality camera 26. The image electrical connection 30 is configured to transmit captured images of the augmented reality camera 26 to the computer 24. A display electrical connection 28 may be provided between the computer 24 and the display monitor 10. The rotary encoder 18 determines the absolute rotational position of display monitor 10 (by determining the absolute rotational position of the shaft of the display monitor 10 relative to the rotational axis of the encoder) in real time. The rotary encoder data is transmitted to the microcontroller 20, which calculates the angle, velocity, acceleration, and other rotational position data of the display monitor 10.

Microcontroller 20 performs additional data smoothing and generates a steady stream of UDP messages to the computer 24. A software plugin on computer 24 intercepts the network traffic, performs additional data smoothing to compensate for network delays, and generates the 3D positional data required to display 3D objects in the correct position relative to display 10.

Each 3D/panoramic object may be a premade panoramic image or content derived from a real-time 3D environment. The transformation is done in real-time, so that the 3D/panoramic object is updated as the user rotates the 2D display monitor 10. The computer 24 may access a 3D object-space data set that represents each 3D/panoramic object in object-space (e.g., the data set identifies every point in object-space that corresponds to a location on the surface of each 3D/panoramic object). The computer 24 may compare the 3D object-space data sets relative to the absolute rotational position data from microcontroller 20 for representing an object transformation vector for each 3D/panoramic object that specifies the orientation of the 3D object in world-space (i.e., specifies the rotational orientation, location, and, in some implementations, scaling of the object). Using the 3D object-space data and the transformation vector data, the computer 24 may calculate a 3D world-space data set that represents the 3D object in world-space (e.g., the data set identifies every point in world-space that corresponds to a location on the surface of each 3D/panoramic object). The computer 24 may determine the 3D world-space data set by, for example, determining an object-space to world-space conversion matrix for the transformation vector and then applying the matrix to the 3D object-space data set for representation of each 3D/panoramic object on the 2d monitor.

An optional AR image, captured by way of an AR camera 26, may be displayed over the 3D or panoramic object represented on the 2D display monitor 10. The 2D display monitor 10 may be configured to provide augmented reality (AR) by superimposing constructed elements over real time 2D or 3D images provided by the user interface. Such constructed images could be obtained from CAD files, or they might be visual objects extracted from a catalog of 3D images. Such AR images can be useful for visualizing proposed changes to an environment.

The real-time 3D environment may be informed by a 3D measuring system, thereby receiving information, such as 3D coordinate information, from the 3D measuring system of the 3D or panoramic object. The display system 100 may compare characteristics of the 3D or panoramic object measured by the 3D measuring system with information on the object stored in memory, for example, on a computer network. For example, a computer network may include a CAD file including dimensional characteristics of an object being measured by one of the mobile 3D measuring systems. These stored dimensional characteristics may be compared to the measured dimensional characteristics to determine whether the characteristics are as expected—for example, whether the dimensions in a CAD file are consistent with dimensions measured by the mobile 3D measuring system.

In one embodiment, the display monitor 10 may be a commercial TV display or touchscreen monitor. The rotating stand 12 just needs to be strong enough to hold all the components. The gears 14 can be any commercially available pair of matched gears. The rotary power coupling 16 needs to match the power requirements of all components (display monitor 10, microcontroller 20, and the computer 24). The rotary power coupling 16 may be a slip ring mounted below the gears 14. The rotary encoder 18 may be an optical quadrature digital encoder with a shaft that attaches to the outer gear to get the rotational position. The data from the rotary encoder 18 goes to the microcontroller 20. The microcontroller 20 has ethernet output, or the like, to connect to the computer 24. The computer can be any PC-based system. The AR camera 26 may be a 1080p or 4 k camera with rectilinear lens. This output is fed to the computer 24 for optional AR overlay along the panoramic content represented on the display monitor 10.

The rotational position data can be used over wireless networks, to connect to different devices, for example the display monitor 10 could instead be an iPad or phone.

A method of using the present invention may include the following. The content to be displayed on the rotating display system 100 can be a panoramic image or video, which can be captured using a commercially available 360 camera (for example the Ricoh Theta™). The display monitor 10 can also be used to display real time 3D computer graphics, such as those created using game engines like Unity™ or Unreal™. The rotating display system 100 may include a plugin for Unity™ to aid in content creation.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, Android, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate. It should be understood, of course, that the foregoing relates to exemplary embodiments of the invention and that modifications may be made without departing from the spirit and scope of the invention as set forth in the following claims.

What is claimed is:

1. A method of displaying 3D visual content on a two-dimensional (2D) display device, the method comprising:
synchronizing a representation of the 3D visual content with a rotation of the 2D display device displaying a portion of the representation.

2. The method of claim 1, wherein a rotary encoder is operatively associated with the 2D display device so as to determines a rotational position data set for the 2D display device, and wherein a computer is configured to control the synchronizing said representation based on the rotational position data set.

3. The method of claim 2, wherein the rotational position data set includes an angular velocity and an angular acceleration for the display device.

4. The method of claim 3, wherein the 3D visual content is a pre-made panoramic image.

5. The method of claim 3, wherein the 3D visual content is a real-time image.

6. The method of claim 3, wherein the computer receives 3D object-space data that represents one or more 3D object defined by the 3D visual content, and wherein the computer is configured to compare the 3D object-space data sets relative to the rotational position data set for representing the 3D visual content on the 2D display device.

7. The method of claim 6, the method further comprising:
operatively associating an augmented reality (AR) camera with the 2D display device, wherein the computer is configured to overlay AR images captured by the AR camera onto the 3D visual content representation.

8. The method of claim 7, wherein the AR is mechanically and directly connected to the 2D display device.

9. A system for representing a 360-degree visual content on a two-dimensional display, the system comprising:
a two-dimensional (2D) display device operatively associated with a rotary power coupling;
a rotary encoder operatively associated with the 2D display device so as to determines a rotational position data set for the 2D display device; and
a computer operatively associated with the 2D display device and the rotary encoder, wherein the computer is configured to synchronize a representation of the 360-degree visual content on the 2D display device based on the rotational position data set.

10. The system of claim 9, further comprising an augmented reality (AR) camera mechanically connected to the 2D display device, wherein the computer is configured to overlay AR images captured by the AR camera onto the representation of the 360-degree visual content.
